(19) United States
(12) Patent Application Publication
(10) Pub. No.: US 2025/0074312 A1
(43) Pub. Date: Mar. 6, 2025

(54) VEHICLE GLASS AND CAMERA UNIT

(71) Applicant: AGC Inc., Tokyo (JP)

(72) Inventors: Kenji KITAOKA, Tokyo (JP); Shinya TANAKA, Tokyo (JP); Reika MIURA, Tokyo (JP); Jiro NISHIHAMA, Tokyo (JP)

(73) Assignee: AGC Inc., Tokyo (JP)

(21) Appl. No.: 18/953,343

(22) Filed: Nov. 20, 2024

Related U.S. Application Data
(63) Continuation of application No. PCT/JP2023/019869, filed on May 29, 2023.

(30) Foreign Application Priority Data
May 30, 2022 (JP) 2022-088040

(51) Int. Cl. B60R 1/30; B60J 10/50; B60R 11/04

(52) U.S. Cl. CPC B60R 1/30; B60J 10/50; B60R 11/04

(57) ABSTRACT

Sound leakage is suppressed while far-infrared rays are appropriately transmitted. Vehicle glass 1 includes: a glass member 10 in which an opening portion 19 penetrating from a surface 10A on a vehicle exterior side to a surface 10B on a vehicle interior side is formed; a transmission member 20 that is arranged in the opening portion 19 and transmits far-infrared rays; and a cover portion 30 that covers a surface 20b on the vehicle interior side of the transmission member 20. The cover portion 30 blocks a first space S1 that is on the vehicle interior side compared to the glass member 10 and that includes the surface 20b on the vehicle interior side of the transmission member 20 from a space other than the first space S1 on the vehicle interior side compared to the glass member 10.

### FIELD

The present invention relates to a vehicle glass and a camera unit.

### BACKGROUND

In recent years, there are cases where various sensors are attached to improve safety of an automobile. Examples of the sensors attached to the automobile include a camera, light detection and ranging (LiDAR), a millimeter wave radar, and a far-infrared camera.

Normally, window glass of an automobile does not transmit far-infrared rays having a wavelength of 8 μm to 13 μm. Thus, for example, Patent Literature 1 describes that an opening is formed in vehicle glass and a transmission member that transmits far-infrared rays is provided in the opening. As a result, the far-infrared rays transmitted through the transmission member can be detected by a far-infrared camera.
Patent Literature 1: WO 2021/182290 A

### SUMMARY

### Technical Problem

However, in a case where an opening is formed in glass and a transmission member is provided, there is a possibility that sound leakage is occurred from a portion where the transmission member is provided. Thus, it is required to suppress the sound leakage while appropriately transmitting far-infrared rays.

The present invention has been made in view of the above problem, and an object thereof is to provide a vehicle glass and a camera unit capable of suppressing sound leakage while appropriately transmitting far-infrared rays.

### Solution to Problem

A vehicle glass of the present disclosure comprises: a glass member in which an opening portion penetrating from a surface on a vehicle exterior side to a surface on a vehicle interior side is formed; a transmission member that is arranged in the opening portion and transmits far-infrared rays; and a cover portion that covers a surface on the vehicle interior side of the transmission member, wherein the cover portion blocks a first space that is on the vehicle interior side compared to the glass member and that includes the surface on the vehicle interior side of the transmission member from a space other than the first space on the vehicle interior side compared to the glass member.

A camera unit of the present disclosure comprises: the vehicle glass; and a far-infrared camera provided in the first space.

### Advantageous Effects of Invention

According to the present invention, it is possible to suppress sound leakage while appropriately transmitting far-infrared rays.

### BRIEF DESCRIPTION OF DRAWINGS

FIG. 1 is a schematic diagram illustrating a state in which vehicle glass according to the present embodiment is mounted on a vehicle.

FIG. 2 is a schematic plan view of the vehicle glass according to the present embodiment.

FIG. 3A is a cross-sectional view taken along a line A-A in FIG. 2.

FIG. 3B is a cross-sectional view taken along the line A-A in FIG. 2.

FIG. 4 is a cross-sectional view taken along a line B-B in FIG. 2.

FIG. 5 is a schematic cross-sectional view of the vehicle glass according to the present embodiment.

FIG. 6 is a schematic diagram of a first space of a case of being viewed in a Z direction.

FIG. 7 is a schematic diagram of a case where a transmission member is viewed in a perpendicular direction from a vehicle exterior side.

FIG. 8 is a graph illustrating an evaluation result of each example.

### DESCRIPTION OF EMBODIMENTS

Hereinafter, a preferred embodiment of the present invention will be described in detail with reference to the accompanying drawings. Note that the present invention is not limited by the embodiment, and in a case where there is a plurality of embodiments, the present invention includes a combination of the embodiments. In addition, a numerical value includes a range of rounding.

### (Vehicle)

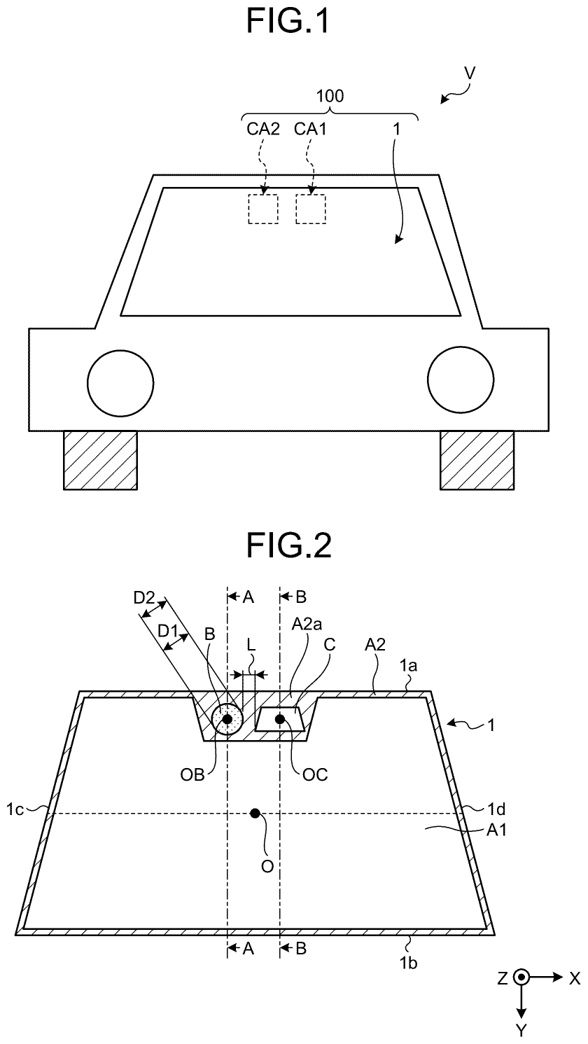

FIG. 1 is a schematic diagram illustrating a state in which vehicle glass according to the present embodiment is mounted on a vehicle. As illustrated in FIG. 1, vehicle glass 1 according to the present embodiment is mounted on a vehicle V. The vehicle glass 1 is a window member applied to a windshield of a vehicle V. That is, the vehicle glass 1 is used as a front windshield, in other words, windshield glass of the vehicle V. A far-infrared camera CA1 and a visible light camera CA2 are mounted inside the vehicle V (vehicle interior). Note that the inside of the vehicle V (vehicle interior) indicates, for example, a vehicle interior in which a driver seat is provided. The vehicle glass 1 is not limited to being applied to the windshield of the vehicle V, and may be mounted at an arbitrary position of the vehicle V.

The vehicle glass 1, the far-infrared camera CA1, and the visible light camera CA2 are included in a camera unit 100 according to the present embodiment. The far-infrared camera CA1 is a camera that detects far-infrared rays, and captures a thermal image outside of the vehicle V by detecting the far-infrared rays from the outside of the vehicle V. The visible light camera CA2 is a camera that detects visible light, and captures an image outside the vehicle V by detecting the visible light from the outside of the vehicle V. Note that the camera unit 100 may include at least the vehicle glass 1 and the far-infrared camera CA1. In addition to the far-infrared camera CA1 and the visible light camera CA2, the camera unit 100 may further include, for example, LiDAR or a millimeter wave radar. Here, the far-infrared rays are, for example, electromagnetic waves having a wavelength in a wavelength band of 8 μm to 13 μm, and the visible light is, for example, an electromagnetic wave having a wavelength in a wavelength band of 360 nm to 830 nm. Note that the far-infrared rays may be the electromagnetic waves having the wavelength in the wavelength band of 8 μm to 12 μm. In addition, a numerical range represented with “to” means a range including numerical values described before and after “to” as a lower limit value and an upper limit value.

### (Vehicle Glass)

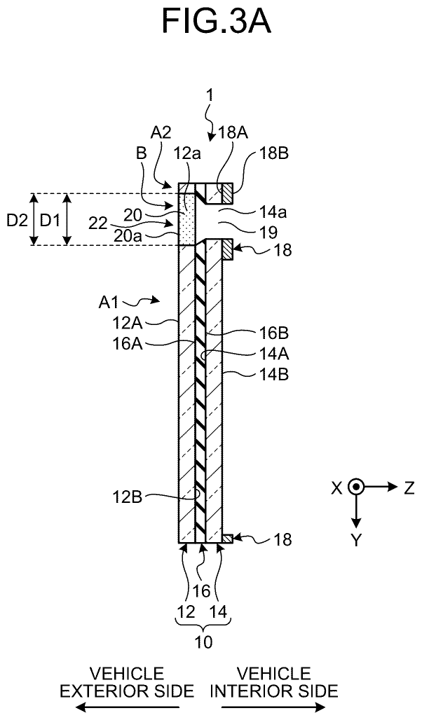

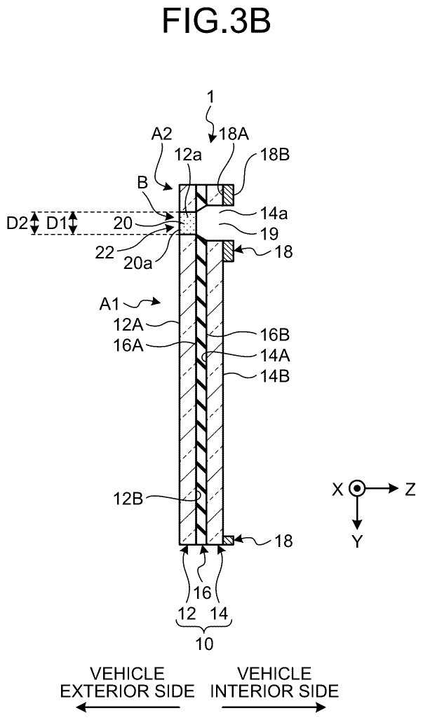

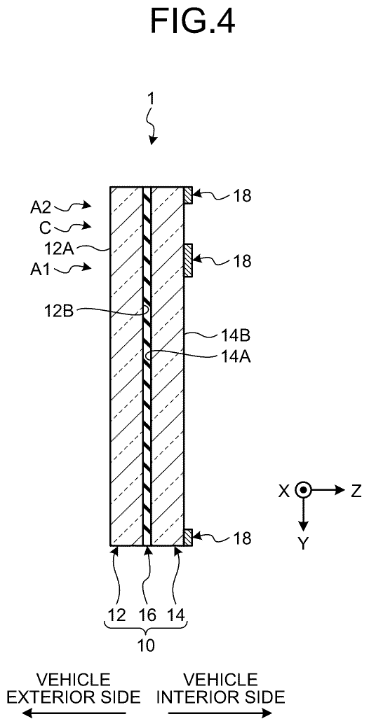

FIG. 2 is a schematic plan view of the vehicle glass according to the present embodiment. FIG. 3A and FIG. 3B are cross-sectional views taken along a line A-A in FIG. 2. FIG. 3A is a cross-sectional view of a case where a glass opening dimension of a vehicle exterior surface is larger than an opening dimension of a vehicle interior surface, and FIG. 3B is a cross-sectional view of a case where the glass opening dimension of the vehicle interior surface is larger than the opening dimension of the vehicle exterior surface. FIG. 4 is a cross-sectional view taken along a line B-B in FIG. 2. As illustrated in FIG. 2, hereinafter, an upper edge of the vehicle glass 1 is referred to as an upper edge portion 1a, a lower edge is referred to as a lower edge portion 1b, one side edge is referred to as a side edge portion 1c, and the other side edge is referred to as a side edge portion 1d. The upper edge portion 1a is an edge portion located on an upper side in a vertical direction when the vehicle glass 1 is mounted on the vehicle V. The lower edge portion 1b is an edge portion located on a lower side in the vertical direction when the vehicle glass 1 is mounted on the vehicle V. The side edge portion 1c is an edge portion located on a side of one side when the vehicle glass 1 is mounted on the vehicle V. The side edge portion 1d is an edge portion located on a side of the other side when the vehicle glass 1 is mounted on the vehicle V.

Hereinafter, in directions parallel to a surface of the vehicle glass 1, a direction from the upper edge portion 1a toward the lower edge portion 1b is referred to as a Y direction, and a direction from the side edge portion 1c toward the side edge portion 1d is referred to as an X direction. In the present embodiment, the X direction and the Y direction are orthogonal to each other. A direction orthogonal to the surface of the vehicle glass 1, that is, a thickness direction of the vehicle glass 1 is referred to as a Z direction. The Z direction is, for example, a direction from a vehicle exterior side toward a vehicle interior side of the vehicle V when the vehicle glass 1 is mounted on the vehicle V. The X direction and the Y direction are along the surface of the vehicle glass 1, but may be directions in contact with the surface of the vehicle glass 1 at a center point O of the vehicle glass 1, for example, in a case where the surface of the vehicle glass 1 is a curved surface. The center point O is a center position of the vehicle glass 1 of a case where the vehicle glass 1 is viewed in the Z direction.

A light transmission region A1 and a light blocking region A2 are formed in the vehicle glass 1. The light transmission region A1 is a region that occupies a central portion of the vehicle glass 1 when viewed in the Z direction. The light transmission region A1 is a region to secure a visual field of a driver. The light transmission region A1 is a region that transmits the visible light. The light blocking region A2 is a region formed around the light transmission region A1 when viewed in the Z direction. The light blocking region A2 is a region that blocks the visible light. In the light blocking region A2, a far-infrared ray transmission region B and a visible light transmission region C are formed in a light blocking region A2a that is a portion on a side of the upper edge portion 1a.

The far-infrared ray transmission region B is a region that transmits the far-infrared rays and is a region where a far-infrared camera CA1 is provided. That is, the far-infrared camera CA1 is provided at a position overlapping with the far-infrared ray transmission region B in a case of being viewed in an optical axis direction of the far-infrared camera CA1. The visible light transmission region C is a region that transmits the visible light and is a region where the visible light camera CA2 is provided. That is, the visible light camera CA2 is provided at a position overlapping with the visible light transmission region C in a case of being viewed in an optical axis direction of the visible light camera CA2.

As described above, since the far-infrared ray transmission region B and the visible light transmission region C are formed in the light blocking region A2, the light blocking region A2 blocks the far-infrared rays in a region other than the region where the far-infrared ray transmission region B is formed, and blocks the visible light in a region other than the region where the visible light transmission region C is formed. The light blocking region A2a is formed around the far-infrared ray transmission region B and the visible light transmission region C. It is preferable to provide the light blocking region A2a around as described above since various sensors are protected from sunlight. Since wiring lines of the various sensors is not visible from the outside of the vehicle, it is preferable from a viewpoint of designability. However, the position where the far-infrared ray transmission region B is formed is not limited to the inside of the light blocking region A2, and may be arbitrary.

As illustrated in FIG. 3A and FIG. 3B, the vehicle glass 1 includes a glass member 10. The glass member 10 includes a glass substrate 12 (first glass substrate), a glass substrate 14 (second glass substrate), an intermediate layer 16, and a light blocking layer 18. In the glass member 10, the glass substrate 12, the intermediate layer 16, the glass substrate 14, and the light blocking layer 18 are laminated in this order in the Z direction. The glass substrate 12 and the glass substrate 14 are fixed (adhered) to each other with the intermediate layer 16 being interposed therebetween.

As the glass substrates 12 and 14, for example, soda-lime glass, borosilicate glass, aluminosilicate glass, or the like can be used. The intermediate layer 16 is an adhesive layer that adheres the glass substrate 12 and the glass substrate 14. As the intermediate layer 16, for example, a polyvinyl butyral (hereinafter, also referred to as PVB) modified material, an ethylene-vinyl acetate copolymer (EVA)-based material, a urethane resin material, a vinyl chloride resin material, or the like can be used. More specifically, the glass substrate 12 includes one surface 12A and the other surface 12B. The other surface 12B is in contact with one surface 16A of the intermediate layer 16 and is fixed (adhered) to the intermediate layer 16. The glass substrate 14 includes one surface 14A and the other surface 14B. The one surface 14A is in contact with the other surface 16B of the intermediate layer 16 and is fixed (adhered) to the intermediate layer 16. As described above, the glass member 10 is laminated glass in which the glass substrate 12 and the glass substrate 14 are laminated. However, the glass member 10 is not limited to the laminated glass, and may include, for example, only one of the glass substrate 12 or the glass substrate 14. In this case, the intermediate layer 16 may not be provided either.

The light blocking layer 18 includes one surface 18A and the other surface 18B. The one surface 18A is in contact with the other surface 14B of the glass substrate 14 and is fixed. The light blocking layer 18 is a layer that blocks the visible light and is preferably a layer that blocks the visible light and the ultraviolet light. As the light blocking layer 18, for example, a ceramic light blocking layer or a light blocking film can be used. As the ceramic light blocking layer, for example, a ceramic layer made of a conventionally-known material, such as a black ceramic layer can be used. As the light blocking film, for example, a light blocking polyethylene terephthalate (PET) film, a light blocking polyethylene naphthalate (PEN) film, a light blocking polymethyl methacrylate (PMMA) film, or the like can be used.

Although a side on which the light blocking layer 18 is provided is an inner side (vehicle interior side) of the vehicle V and a side on which the glass substrate 12 is provided is an outer side (vehicle exterior side) of the vehicle V in the glass member 10 in the present embodiment, this is not a limitation and the light blocking layer 18 may be on the outer side of the vehicle V. In a case where the glass substrates 12 and 14 are made of laminated glass, the light blocking layer 18 may be formed between the glass substrate 12 and the glass substrate 14.

### (Light Blocking Region)

The light blocking layer 18 is provided in the glass member 10, whereby the light blocking region A2 is formed. That is, the light blocking region A2 is a region in which the glass member 10 includes the light blocking layer 18. That is, the light blocking region A2 is a region in which the glass substrate 12, the intermediate layer 16, the glass substrate 14, and the light blocking layer 18 are laminated. On the other hand, the light transmission region A1 is a region where the glass member 10 does not include the light blocking layer 18. That is, the light transmission region A1 is a region where the glass substrate 12, the intermediate layer 16, and the glass substrate 14 are laminated and the light blocking layer 18 is not laminated.

### (Far-Infrared Ray Transmission Region)

As illustrated in FIG. 3, the glass member 10 has an opening portion 19 penetrating from one surface (here, the surface 12A) to the other surface (here, the surface 14B) in the Z direction. A transmission member 20 that transmits the far-infrared rays is provided in the opening portion 19. A region where the opening portion 19 is formed and the transmission member 20 is provided is the far-infrared ray transmission region B. That is, the far-infrared ray transmission region B is a region where the opening portion 19 and the transmission member 20 arranged in the opening portion 19 are provided. Since the light blocking layer 18 does not transmit the far-infrared rays, the light blocking layer 18 is not provided in the far-infrared ray transmission region B. That is, in the far-infrared ray transmission region B, the glass substrate 12, the intermediate layer 16, the glass substrate 14, and the light blocking layer 18 are not provided, and the transmission member 20 is provided in the formed opening portion 19. The transmission member 20 will be described later. Note that it can be said that the vehicle glass 1 includes the glass member 10 and the transmission member 20 provided in the opening portion 19 of the glass member 10. The glass member 10 can be also referred to as a portion included in window glass in the vehicle glass 1. For example, here, a configuration including the glass substrates 12 and 14, the intermediate layer 16, and the light blocking layer 18 may be referred to as the glass member 10. However, as described above, the glass member 10 may include at least one of the glass substrate 12 or the glass substrate 14.

### (Visible Light Region)

As illustrated in FIG. 4, the visible light transmission region C is a region in which the glass member 10 does not include the light blocking layer 18 in the Z direction, similarly to the light transmission region A1. That is, the visible light transmission region C is a region where the glass substrate 12, the intermediate layer 16, and the glass substrate 14 are laminated and the light blocking layer 18 is not laminated.

As illustrated in FIG. 2, the visible light transmission region C is preferably provided in the vicinity of the far-infrared ray transmission region B. Specifically, a center of the far-infrared ray transmission region B viewed in the Z direction is defined as a center point OB, and a center of the visible light transmission region C viewed in the Z direction is defined as a center point OC. When the shortest distance between the far-infrared ray transmission region B (opening portion 19) and the visible light transmission region C of a case of being viewed in the Z direction is defined as a distance L, the distance L is preferably more than 0 mm and 100 mm or less, and more preferably 10 mm or more and 80 mm or less. Although not illustrated here, in a case where there is a plurality of the visible light transmission regions C, a relationship with one of the visible light transmission regions C is illustrated. By setting the visible light transmission region C at a position within these ranges with respect to the far-infrared ray transmission region B, it is possible to capture images at a close position by the far-infrared camera CA1 and the visible light camera CA2, and it is possible to appropriately capture an image by the visible light camera CA2 while controlling an amount of perspective distortion in the visible light transmission region C. When the images at the close position are captured by the far-infrared camera CA1 and the visible light camera CA2, a load in arithmetic processing on data acquired from each of the cameras is reduced, and handling of a power supply and a signal cable also becomes suitable.

As illustrated in FIG. 2, the visible light transmission region C and the far-infrared ray transmission region B are preferably located side by side in the X direction. That is, it is preferable that the visible light transmission region C is not located on a Y direction side of the far-infrared ray transmission region B and is arranged side by side with the far-infrared ray transmission region B in the X direction. By arranging the visible light transmission region C and the far-infrared ray transmission region B side by side in the X direction, it is possible to reduce a parallax between the far-infrared camera and the visible light camera as much as possible, whereby an object recognition rate on a target object is improved, and the visible light transmission region C can be arranged in the vicinity of the upper edge portion 1a. Thus, the visual field of the driver in the light transmission region A1 can be appropriately secured. Note that being located side by side in the X direction means being within a range of +50 mm in the Y direction.

### (Configuration of the Vehicle Glass)

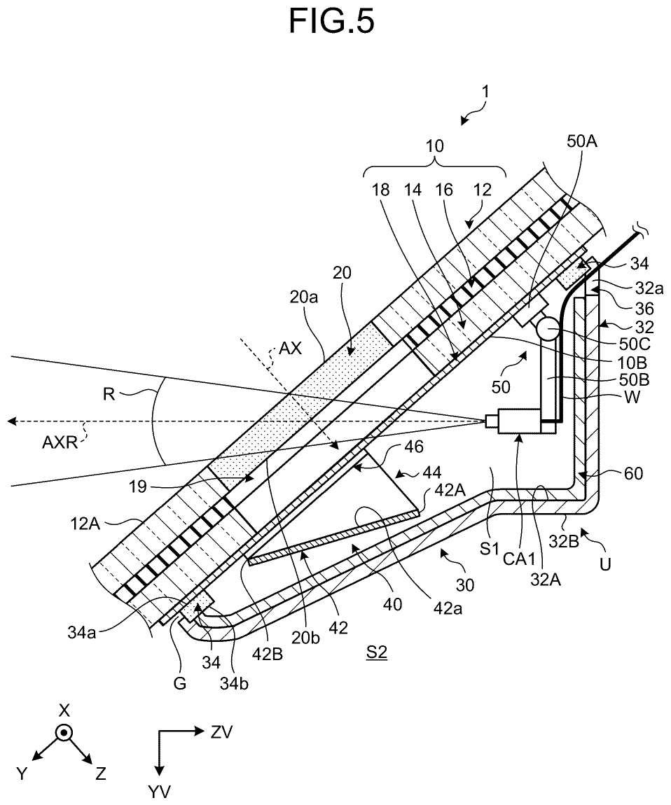

FIG. 5 is a schematic cross-sectional view of the vehicle glass according to the present embodiment. As illustrated in FIG. 5, the vehicle glass 1 according to the present embodiment includes a cover portion 30, a protection member 40, a camera attachment portion 50, and a sound absorbing material 60 in addition to the glass member 10 and the transmission member 20. Note that the far-infrared camera CA1 may be treated as being included in the vehicle glass 1, or may be treated as being separated from the vehicle glass 1. Furthermore, for example, the far-infrared camera CA1 and the vehicle glass 1 may be included the camera unit 100 attached to the vehicle glass 1 (glass member 10).

(Attachment position of the glass member)

As illustrated in FIG. 5, the glass member 10 is attached to the vehicle V in such a manner as to be inclined in the vertical direction. Thus, when a direction along a lower side in the vertical direction is a direction YV, a direction Y of the glass member 10 in a state of being attached to the vehicle V is inclined with respect to the direction YV, and a surface 20a on the vehicle exterior side of the transmission member 20 is also inclined with respect to the direction YV. In addition, when a direction from a front side to a rear side of the vehicle V in a horizontal direction is a direction ZV, a direction Z of the glass member 10 in a state of being attached to the vehicle V is inclined with respect to the direction ZV, and a perpendicular line AX orthogonal to the surface 20a of the transmission member 20 is also inclined with respect to the direction ZV. However, the glass member 10 is not limited to being attached to the vehicle V in such a manner as to be inclined in the vertical direction. For example, the direction Y of the glass member 10 and the surface 20a of the transmission member 20 in a state of being attached to the vehicle V may be in the direction YV, and the direction Z and the perpendicular line AX of the glass member 10 in a state of being attached to the vehicle V may be in the direction ZV. Hereinafter, unless otherwise specified, a state in which the glass member 10 is attached to the vehicle V will be described.

### (Attachment Position of the Far-Infrared Camera)

The far-infrared camera CA1 is provided in the vehicle V. The far-infrared camera CA1 is provided on the vehicle interior side compared to the transmission member 20 of the vehicle glass 1, that is, on a direction ZV side (direction Z side) compared to the transmission member 20. The far-infrared camera CA1 is provided in such a manner that an optical axis AXR passes through the transmission member 20. Furthermore, the far-infrared camera CA1 is provided in such a manner that a detection range R passes through the transmission member 20. The detection range R represents a range (imaging range) that can be detected by the far-infrared camera CA1, and it can be said that the far-infrared camera CA1 receives and detects the far-infrared rays incident through the detection range R. Note that the detection range R can be said to be a space that expands around the optical axis AXR at a predetermined viewing angle as a distance from the far-infrared camera CA1 becomes longer. The size and viewing angle of the detection range R may be appropriately set according to a distance and range desired to be detected by the far-infrared camera.

In addition, in the present embodiment, in the far-infrared camera CA1, the optical axis AXR is inclined with respect to the perpendicular line AX of the transmission member 20. That is, the optical axis AXR of the far-infrared camera CA1 is not along the surface 20a of the transmission member 20 and is not orthogonal to the surface 20a of the transmission member 20. For example, an angle formed by the optical axis AXR and the direction ZV may be smaller than an angle formed by the perpendicular line AX of the transmission member 20 and the direction ZV. However, the relationship between the optical axis AXR and the perpendicular line AX is not limited the above. For example, the far-infrared camera CA1 may be provided in such a manner that the optical axis AXR is along the perpendicular line AX of the transmission member 20.

### (Transmission Member)

Hereinafter, the transmission member 20 provided in the far-infrared ray transmission region B will be specifically described. The transmission member 20 is a member that transmits the far-infrared rays. As illustrated in FIG. 3A and FIG. 3B, the transmission member 20 is preferably formed in such a manner that a plane on the vehicle exterior side is flush (continuous) with a plane on the vehicle exterior side of the light blocking region A2. In other words, it is preferable that the surface 20a on the vehicle exterior side of the transmission member 20 is attached in such a manner as to be continuous with the surface 12A of the glass substrate 12. As described above, since the surface 20a of the transmission member 20 is continuous with the surface 12A of the glass substrate 12, a wiping effect of a wiper can be controlled from being impaired. In addition, it is possible to control a risk that design of the vehicle V is impaired due to presence of a step or that dust or the like accumulates on the step. Furthermore, the transmission member 20 is preferably formed in accordance with a curved surface shape of the applied vehicle glass 1. A method of forming the transmission member 20 is not specifically limited, and polishing or molding is selected according to the curved surface shape or the member.

A shape of the transmission member 20 is not specifically limited, and is preferably a plate-like shape adjusted to a shape of the opening portion 19. That is, for example, in a case where the opening portion 19 is circular, the transmission member 20 preferably has a disk shape (columnar shape). In addition, from a viewpoint of designability, the surface shape of the transmission member 20 on the vehicle exterior side may be processed in such a manner as to match a curvature of an outer surface shape of the glass substrate 12. Furthermore, the transmission member 20 may have a lens shape in order to achieve both widening of the viewing angle of the far-infrared camera CA1 and improvement of a mechanical characteristic. Such a configuration is preferable since far-infrared light can be efficiently collected even when an area of the transmission member 20 is small. In this case, the number of the lens-shaped transmission members 20 is preferably 1 to 3, and is typically preferably 2. Furthermore, it is specifically preferable that the lens-shaped transmission member 20 is aligned in advance and modularized, and is integrated with a housing or a bracket that adheres the far-infrared camera CA1 to the vehicle glass 1.

In the vehicle glass 1 of the present embodiment, as a configuration example of the opening portion 19, as illustrated in FIG. 3A, it is preferable that an area of the opening portion 19 in the plane on the vehicle interior side is smaller than the area of the opening portion 19 in the plane on the vehicle exterior side. With such a configuration, strength against impact from the vehicle exterior side is improved. In this case, the shape of the transmission member 20 may be adjusted to that of the opening portion 19 on the vehicle exterior side. Furthermore, in a case where the glass member 10 of the present embodiment is laminated glass including the glass substrate 12 (vehicle exterior side) and the glass substrate 14 (vehicle interior side), the opening portion 19 is formed by the opening portion 12a of the glass substrate 12 and the opening portion 14a of the glass substrate 14 overlapping with each other. In this case, an area of the opening portion 12a of the glass substrate 12 is made larger than an area of the opening portion 14a of the glass substrate 14, and the transmission member 20 adjusted to the size of the opening portion 12a of the glass substrate 12 may be arranged in the opening portion 12a of the glass substrate 12. It is possible to realize the structure of FIG. 3A, for example, by accurately processing the positions and sizes of the opening portion 12a of the glass substrate 12 and the opening portion 14a of the glass substrate 14 and performing lamination in such a manner that a positional deviation is reduced.

As an example of the opening portion 19, as illustrated in FIG. 3B and FIG. 5, the area of the opening portion 19 in the plane on the vehicle exterior side may be smaller than the area of the opening portion 19 in the plane on the vehicle interior side. In this case, the shape of the transmission member 20 may be adjusted to that of the opening portion 19 on the vehicle exterior side. Furthermore, in a case where the vehicle glass 1 of the present embodiment is laminated glass including the glass substrate 12 (vehicle exterior side) and the glass substrate 14 (vehicle interior side), the opening portion 12a of the glass substrate 12 and the opening portion 14a of the glass substrate 14 are overlapped and the opening portion 19 is formed. In this case, the area of the opening portion 14a of the glass substrate 14 may be made larger than the area of the opening portion 12a of the glass substrate 12, and the transmission member 20 adjusted to the size of the opening portion 12a of the glass substrate 12 may be arranged in the opening portion 12a of the glass substrate 12. In such a configuration, it is preferable that a rotational axis deviation (for convenience, deviation of a center position) between a central axis of the opening portion 12a formed in the glass substrate 12 and the opening portion 14a formed in the glass substrate 14 and a glass surface is as small as possible from a point that an outer peripheral width of a frame member 52 (described later) can be narrowed and a preferable appearance can be acquired and a point that the area of the opening portion 19 of the transmission member 20 can be increased.

In addition, as illustrated in FIG. 3A and FIG. 3B, in the transmission member 20, a length D1 of a longest straight line among straight lines connecting arbitrary two points in the plane on the vehicle exterior side is preferably 100 mm or less. The length is more preferably 80 mm or less. The length D1 is more preferably 60 mm or less, and specifically preferably 55 mm or less. In addition, the length D1 is preferably 45 mm or more. The length D1 is preferably 45 mm or more and 100 mm or less, more preferably 45 mm or more and 80 mm or less, more preferably 45 mm or more and 60 mm or less, and more preferably 45 mm or more and 55 mm or less. Furthermore, as illustrated in FIG. 3A, in the opening portion 19 of the far-infrared ray transmission region B, a length D2 of a longest straight line among straight lines connecting arbitrary two points in the plane on the vehicle exterior side (here, arbitrary two points on an edge of a portion opened to a side of the front surface 12A of the opening portion 19) is preferably 110 mm or less. The length D2 is more preferably 85 mm or less, still more preferably 65 mm or less, and specifically preferably 60 mm or less. In addition, the length D2 is preferably 50 mm or more. The length D2 is preferably 50 mm or more and 110 mm or less, more preferably 50 mm or more and 85 mm or less, more preferably 50 mm or more and 65 mm or less, and more preferably 50 mm or more and 60 mm or less. It can be said that the length D2 is the length of the longest straight line among the straight lines connecting arbitrary two points on an outer periphery of the opening portion 19 in the plane (surface 12A) on the vehicle exterior side of the vehicle glass 1. By setting the length D1 of the transmission member 20 and the length D2 of the opening portion 19 within these ranges, it is possible to control a decrease in the strength of the vehicle glass 1 and also control the amount of perspective distortion around the opening portion 19. Note that the lengths D1 and D2 are lengths corresponding to a diameter of the surface on the vehicle exterior side in a case where a shape of the plane on the vehicle exterior side of the transmission member 20 is circular. In addition, the lengths D1 and D2 here represent the lengths in a state in which the vehicle glass 1 is mounted on the vehicle V. For example, in a case where the glass is bent and a shape to be mounted on the vehicle V is acquired, the lengths D1 and D2 are the lengths in a state after the bending. The same applies to the description of dimensions and positions other than the lengths D1 and D2 unless otherwise specified.

The transmission member 20 includes a base material 22 that is a member capable of transmitting the far-infrared rays. The base material 22 has internal transmittance of preferably 50% or more, more preferably 60% or more, and still more preferably 70% or more with respect to light having a wavelength of 10 μm (far-infrared rays). In addition, the base material 22 has average internal transmittance of preferably 50% or more, more preferably 608 or more, and still more preferably 708 or more with respect to light having a wavelength of 8 μm to 13 μm (far-infrared rays). When the internal transmittance of the base material 22 at 10 μm and the average internal transmittance thereof at 8 μm to 13 μm fall within these numerical ranges, the far-infrared rays can be appropriately transmitted, and performance of the far-infrared camera CA1 can be sufficiently exhibited, for example. Here, the average internal transmittance is an average value of the internal transmittance of the wavelength band (here, 8 μm to 12 μm) with respect to the light of each wavelength.

The internal transmittance of the base material 22 is transmittance excluding a surface reflection loss on an incident side and an emission side and is well known in the technical field, and may be measured by a method usually performed. The measurement is performed, for example, as follows.

A pair of plate-like samples (first sample and second sample) that are made of a base material having the same composition and that have different thicknesses is prepared. Both planes of each of the plate-like samples are plane surfaces parallel to each other and optically polished. When it is assumed that external transmittance including the surface reflection loss of the first sample is T1, external transmittance including the surface reflection loss of the second sample is T2, a thickness of the first sample is Td1 (mm), a thickness of the second sample is Td2 (mm), and Td1<Td2, internal transmittance t at a thickness Tdx (mm) can be calculated by the following expression (1).

$$τ = exp [ - Tdx \times ( ln T 1 - ln T 2 ) / Δ Td ] \qquad ( 1 )$$

Note that the external transmittance of the infrared rays can be measured by, for example, a Fourier transform-type infrared spectroscopic device (manufactured by ThermoScientific Inc., product name: Nicolet iS10).

A refractive index of the base material 22 with respect to the light having the wavelength of 10 μm is preferably 1.5 or more and 4.0 or less, more preferably 2.0 or more and 4.0 or less, and still more preferably 2.2 or more and 3.5 or less. When the refractive index of the base material 22 falls within these numerical ranges, the far-infrared rays can be appropriately transmitted, and the performance of the far-infrared camera CA1 can be sufficiently exhibited, for example. It is possible to determine the refractive index by performing fitting of an optical model by using, for example, polarization information acquired by an infrared spectroscopic ellipsometer (IR-VASE-UT manufactured by J.A. Woollam Co., Inc.) and a spectral transmission spectrum acquired by the Fourier transform-type infrared spectroscopic device.

A thickness D0 of the base material 22 is preferably 1.5 mm or more and 5 mm or less, more preferably 1.7 mm or more and 4 mm or less, and still more preferably 1.8 mm or more and 3 mm or less. When the thickness DO is in these ranges, the far-infrared rays can be appropriately transmitted while the strength being secured.

A material of the base material 22 is not specifically limited, and examples thereof include Si, Ge, ZnS, and chalcogenide glass. It can be said that the base material 22 preferably includes at least one material selected from a group of Si, Ge, ZnS, and the chalcogenide glass. By using such a material for the base material 22, the far-infrared rays can be appropriately transmitted.

Preferred composition of the chalcogenide glass include:
in atom %
Ge+Ga; 7% to 25%,
Sb; 0% to 35%,
Bi; 0% to 20%,
Zn; 0% to 20%,
Sn; 0% to 20%,
Si; 0% to 20%,
La; 0% to 20%,
S+Se+Te; 55% to 80%,
Ti; 0.005% to 0.3%,
Li+Na+K+Cs; 0% to 20%, and
F+Cl+Br+1; 0% to 20%. The glass preferably has a glass transition point (Tg) of 140° C. to 550° C.

Note that it is more preferable that Si or ZnS is used as the material of the base material 22.

In addition, the transmission member 20 may be provided with a frame member (not illustrated) on an outer peripheral edge and attached to the opening portion 19 via the frame member.

### (Cover Portion)

The cover portion 30 is a cover that is provided in the vehicle V and covers a surface 20b on the vehicle interior side of the transmission member 20. The cover portion 30 is attached to a surface 10B of the glass member 10 on the vehicle interior side in such a manner as to cover the surface 20b of the transmission member 20. Here, a space in the vehicle which space is covered by the cover portion 30 (space in the cover portion 30) is defined as a first space S1. It can be also said that the first space S1 is a space surrounded by an inner surface of the cover portion 30 (inner surface 32A of a housing 32 (described later) in the example of the present embodiment), the surface 10B of the glass member 10 on the vehicle interior side, and the surface 20b of the transmission member 20 on the vehicle interior side, and that the surface 20b of the transmission member 20 is included in the first space S1. In the present embodiment, the protection member 40, the camera attachment portion 50, the far-infrared camera CA1 fixed to the camera attachment portion 50, and the sound absorbing material 60 are provided in the first space S1.

The cover portion 30 blocks the first space S1 from a second space S2 that is not covered by the cover portion 30 in the space inside the vehicle (space other than the first space S1 on the vehicle interior side). Here, blocking means that the cover portion 30 covers the first space S1 without a gap. For example, in a case where air is supplied to the first space S1 in such a manner that the first space S1 is higher than the second space S2 by 1 atm, when a pressure difference between the first space S1 and the second space S2 is 0.9 atm or more, it may be determined that the cover portion 30 blocks the first space S1 and the second space S2.

Since the cover portion 30 blocks the first space S1, sound leakage to the vehicle interior side due to formation of the opening portion 19 in the glass member 10 can be appropriately suppressed.

### (Housing)

In the present embodiment, the cover portion 30 preferably includes the housing 32 and a fixation portion 34. The housing 32 is a cover that covers the first space S1. The housing 32 is attached to the glass member 10 in such a manner that one surface side is opened and an opened side faces the surface 10B on the vehicle interior side of the glass member 10.

In the present embodiment, an outlet 32a that is an opening through which a wiring line W of the far-infrared camera CA1 passes is formed in the housing 32 The outlet 32a is an opening penetrating from the inner surface 32A to an outer surface 32B of the housing 32. The wiring line W extends from the far-infrared camera CA1 in the first space S1 to the outside of the first space S1 (inside of the second space S2) through the outlet 32a. Although the outlet 32a is formed in the vicinity of an outer peripheral edge on the opening side of the housing 32 in the example of FIG. 5, a position where the outlet 32a is formed may be arbitrary. In addition, the outlet 32a is not an essential component. For example, in a case where the wiring line is not provided in the far-infrared camera CA1, the outlet 32a may not be formed.

The housing 32 may be made of any material, and may be, for example, a resin member that does not transmit the visible light. Thus, it is possible to control the far-infrared camera CA1 or the like from being visually recognized by an occupant or the like of the vehicle V.

### (Fixation Portion)

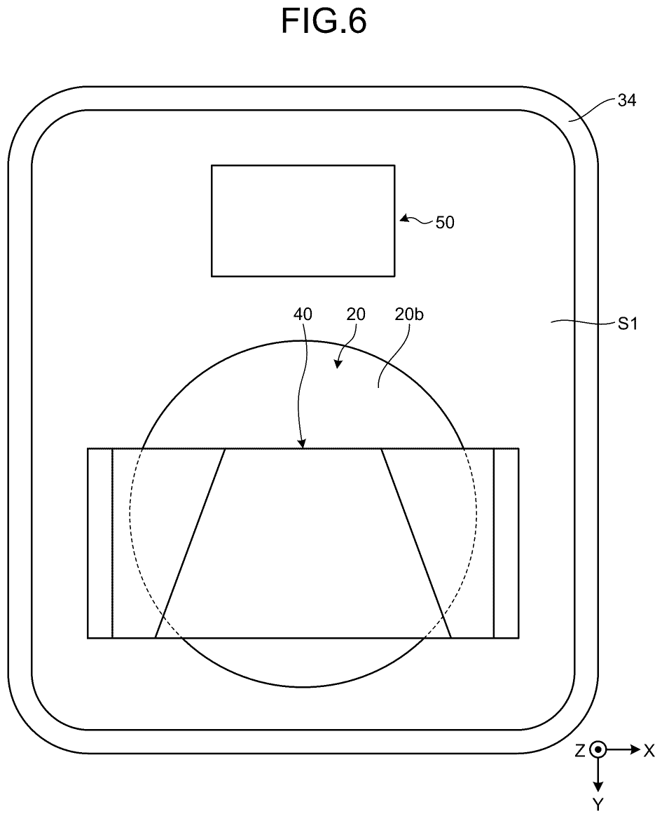

FIG. 6 is a schematic diagram of the first space of a case of being viewed in the Z direction. The fixation portion 34 is a member that fixes the housing 32 to the surface 10B of the glass member 10. As illustrated in FIG. 6, the fixation portion 34 is a frame-shaped member surrounding an outer periphery of the first space S1 (surface 20b of the transmission member 20) in a case of being viewed in the Z direction. The fixation portion 34 preferably has a shape that extends without interruption over the entire section of the outer periphery of the first space S1 (surface 20b of the transmission member 20) when viewed in the Z direction.

As illustrated in FIG. 5, the fixation portion 34 closes a gap G formed between the surface 10B of the glass member 10 and the outer peripheral edge of the housing 32. In the example of FIG. 5, the fixation portion 34 is located between the glass member 10 and the housing 32 in the Z direction and closes the gap G. A surface 34a on the vehicle exterior side (side opposite to the Z direction) of the fixation portion 34 is fixed while being in contact with the surface 10B of the glass member 10. Furthermore, the surface 34b on the vehicle interior side (Z direction side) of the fixation portion 34 is fixed while being in contact with the outer peripheral edge of the housing 32. However, the shape of the fixation portion 34 is not limited to the above, and may be any shape that closes the gap G between the glass member 10 and the housing 32. For example, the fixation portion 34 may be provided in such a manner as to surround the outer peripheral edge of the housing 32 when viewed in the Z direction and close the gap G.

A material of the fixation portion 34 may be arbitrary, and may be, for example, rubber or the like or an adhesive.

In addition, in a case where the outlet 32a is formed in the cover portion 30, it is preferable that a closing portion 36 that closes the outlet 32a is further provided. Since the wiring line W passes through the outlet 32a, the closing portion 36 is provided in such a manner as to close a region other than a region occupied by the wiring line W in the outlet 32a. A material of the closing portion 36 is arbitrary, and may be, for example, rubber or the like or an adhesive.

Note that not only the far-infrared camera CA1 but also the visible light camera CA2 and another device may be housed in the cover portion 30.

Furthermore, a heater or the like may be included in the cover portion 30 in order to prevent fogging of the surfaces of the glass member 10 and the transmission member 20 on the vehicle interior side and to provide a snow melting function.

### (Protection Member)

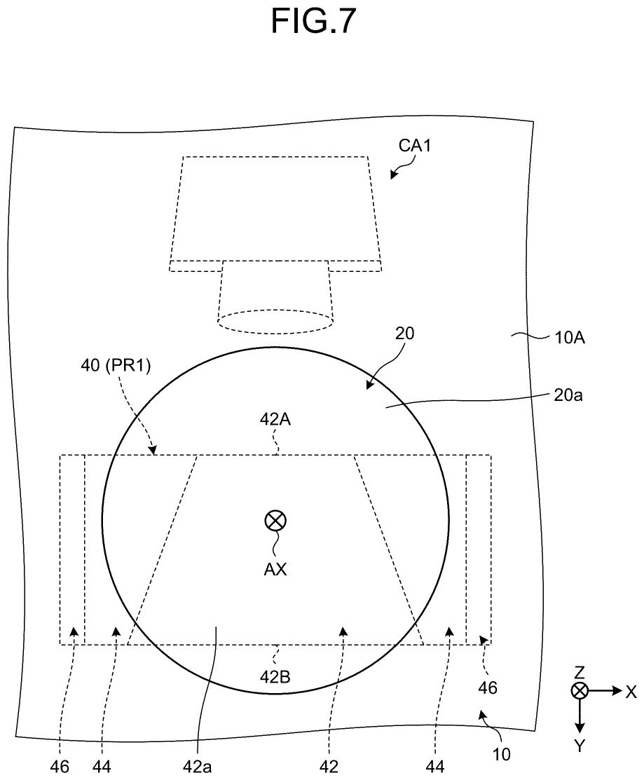

FIG. 7 is a schematic diagram of a case where the transmission member is viewed in a perpendicular direction from the vehicle exterior side. As illustrated in FIG. 5, the protection member 40 is provided in the first space S1. The protection member 40 is provided on the vehicle interior side (direction ZV side) compared to the transmission member 20. In addition, as illustrated in FIG. 7, the protection member 40 overlaps with at least a part of the transmission member 20 in a case of being viewed in the direction along the perpendicular line AX (direction orthogonal to the surface 20a of the transmission member 20). In other words, at least a part of the protection member 40 and at least a part of the transmission member 20 overlap with each other in a case of being viewed in the direction along the perpendicular line AX. As a result, even when a collision object penetrates the transmission member 20, the collision object is received by the protection member 40, and it is possible to prevent the collision object from reaching a side of the driver seat. Furthermore, as illustrated in FIG. 5, in the present embodiment, the protection member 40 is preferably provided on the vehicle exterior side (side of a direction opposite to the direction ZV) compared to the far-infrared camera CA1, and is preferably provided at a position not overlapping with the detection range R of the far-infrared camera CA1. That is, the protection member 40 is preferably located outside the detection range R without interfering with the detection range R. As a result, the far-infrared rays incident on the far-infrared camera CA1 are prevented from being blocked by the protection member 40, and a decrease in detection accuracy of the far-infrared rays can be controlled.

More specifically, the protection member 40 includes a surface portion 42, a protrusion portion 44, and a fixation portion 46. As illustrated in FIG. 7, the surface portion 42 is provided at a position overlapping with at least a part of the transmission member 20 in a case of being viewed in the direction along the perpendicular line AX. The surface portion 42 preferably overlaps with a region having an area of 30% or more of the entire region of the transmission member 20 in a case of being viewed in the direction along the perpendicular line AX. In other words, when a region overlapping with the surface portion 42 in the entire region of the transmission member 20 in a case of being viewed in the direction along the perpendicular line AX is defined as an overlapping region, an area of the overlapping region is preferably 30% or more with respect to the area of the entire region of the transmission member 20. In a case where the area of the overlapping region is 30% or more of the area of the entire region of the transmission member 20, the collision energy can be sufficiently absorbed by the protection member even in a case where the collision object penetrates the transmission member 20. In addition, the area of the overlapping region is more preferably 35% or more, and still more preferably 40% or more of the area of the entire region of the transmission member 20. On the other hand, the area of the overlapping region is preferably less than 90% of the area of the entire region of the transmission member 20. When the area of the overlapping region is less than 90% of the area of the entire region of the transmission member 20, there is no possibility that the protection member 40 interferes with the detection range R. In addition, the area of the overlapping region is more preferably 85% or less, and still more preferably 80% or less of the area of the entire region of the transmission member 20. When the area of the overlapping region is within these ranges, it is possible to suitably prevent the collision object penetrating the transmission member 20 from reaching the driver seat. Note that the protection member 40 may be subjected to mesh processing or punching processing for the purpose of weight reduction or the like. In other words, an opening may be formed in the surface portion 42 of the protection member 40. In a case where the opening is formed in the surface portion 42 of the protection member 40, the area of the opening is also included in the area of the overlapping region of the protection member 40. In other words, in the entire region of the transmission member 20, a region that is a combination of a region overlapping with a portion where the opening is not formed in the surface portion 42 and a region overlapping with a portion where the opening is formed in the surface portion 42 (in other words, a region overlapping with a region surrounded by a peripheral edge of the protection member 40 in the entire region of the transmission member 20) is set as the overlapping region. Note that in a case where the opening is formed in the surface portion 42 of the protection member 40, an area of each opening is preferably ϕ10 mm or less in terms of a diameter. When the area of the opening is ϕ10 mm or less, there is no possibility that a function as the protection member is impaired even in a case where a flying stone or the like collides with the transmission member 20. The area of the opening is preferably ϕ8 mm or less, and more preferably ϕ5 mm or less. For example, the area being ϕ10 mm or less in terms of the diameter means that the area is equal to or smaller than an area of a circle having a diameter of 10 mm.

The surface portion 42 is provided at a position not overlapping with the detection range R of the far-infrared camera CA1. In the example of the present embodiment, the surface portion 42 is located on the side of the direction YV (lower side in the vertical direction) compared to the detection range R. In other words, it can be said that the surface portion 42 is located below the far-infrared camera CA1 in the vertical direction. That is, in the present embodiment, it can be said that the surface portion 42 is located on the side of the direction YV (lower side in the vertical direction) compared to the far-infrared camera CA1 and on the vehicle exterior side (side opposite to the direction ZV).

The surface portion 42 is a plate-like member and extends from an end portion 42B to an end portion 42A. The surface portion 42 has a planar shape in the present embodiment. The end portion 42B is an end portion of the surface portion 42 on the side of the direction ZV (vehicle exterior side), and the end portion 42A is an end portion of the surface portion 42 on the opposite side of the direction ZV (vehicle interior side). In addition, it can be said that the end portion 42B is the end portion of the surface portion 42 on a side far from the far-infrared camera CA1, and the end portion 42A is the end portion of the surface portion 42 on a side close to the far-infrared camera CA1. However, a shape of the surface portion 42 may be arbitrary, and may be a curved surface shape or may not be a plate-like shape, for example.

The protection member 40 may be made of any material, but is preferably made of a material having higher breaking strength than the transmission member 20. In addition, the protection member 40 is preferably made of a material having higher breaking strength than the cover portion 30. Examples of the material of the protection member 40 include stainless steel, an aluminum alloy, a copper alloy, and a fiber-reinforced resin. Examples of the fiber-reinforced resin include glass-reinforced polycarbonate and the like. Note that the breaking strength may be, for example, a value obtained by division of a load of when a test piece is broken when a tensile strength test is performed according to JIS Z2241 by a minimum cross-sectional area of a broken portion.

Note that the protection member 40 is not an essential component.

### (Camera Attachment Portion)

As illustrated in FIG. 5, the camera attachment portion 50 is provided in the first space S1. The camera attachment portion 50 is a mechanism that fixes the far-infrared camera CA1 to the surface 10B on the vehicle interior side of the glass member 10. The camera attachment portion 50 includes a base portion 50A, an extension portion 50B, and an adjustment portion 50C. The base portion 50A is a member fixed to the surface 10B. The extension portion 50B is a member that extends from the base portion 50A and fixes the far-infrared camera CA1. The adjustment portion 50C is a mechanism that is provided in the extension portion 50B and adjusts a position of the extension portion 50B with respect to the base portion 50A. For example, the adjustment portion 50C adjusts the position of the extension portion 50B with respect to the base portion 50A by changing a direction of the extension portion 50B with respect to the base portion 50A. However, the configuration of the camera attachment portion 50 is not limited to what has been described above, and may be any configuration that fixes the far-infrared camera CA1 to the glass member 10. Furthermore, the camera attachment portion 50 is not an essential configuration.

### (Sound Absorbing Material)

The sound absorbing material 60 is a member that is provided in the first space S1 and absorbs at least a part of a sound wave. By providing the sound absorbing material 60, it is possible to more appropriately control the sound leakage to the vehicle interior side.

Preferably, the sound absorbing material 60 is not provided between the transmission member 20 and the far-infrared camera CA1 in the direction along the optical axis AXR, and is provided at another place. In the example of FIG. 5, the sound absorbing material 60 is provided on the inner surface of the cover portion 30 (inner surface 32A of the housing 32). However, the position where the sound absorbing material 60 is provided may be arbitrary.

A material of the sound absorbing material 60 may be arbitrary, and may be, for example, at least one of urethane foam, polyethylene foam, melamine foam, synthetic rubber sponge, glass wool, felt, or nonwoven fabric. By using these materials as the material of the sound absorbing material 60, it is possible to more appropriately control the sound leakage to the vehicle interior side. Among these materials, a flexible urethane foam material is preferable in consideration of scattering of the material and ease of processing in construction. Crosslinked polyethylene foam having high moisture resistance is also preferred.

Note that although not being the essential configuration, in a case of being used, the sound absorbing material 60 is preferably attached to the housing 32 in such a manner as to cover the first space S1 and is preferably arranged at a position where the arrangement of the protection member 40, the camera attachment portion 50, and the far-infrared camera CA1 and image acquisition by the far-infrared camera CA1 are not hindered.

### Effect

As described above, the vehicle glass 1 according to the present embodiment includes the glass member 10 in which the opening portion 19 penetrating from a surface 10A on the vehicle exterior side to the surface 10B of the vehicle interior side is formed, the transmission member 20 that is arranged in the opening portion 19 and transmits the far-infrared rays, and the cover portion 30 that covers the surface 20b on the vehicle interior side of the transmission member 20. The cover portion 30 blocks the first space S1 that is on the vehicle interior side compared to the glass member 10 and that includes the surface 20b on the vehicle interior side of the transmission member 20 from the space other than the first space S1 on the vehicle interior side compared to the glass member 10 (second space S2).

Here, in the configuration in which the opening is formed in the glass and the transmission member is provided, there is a possibility that the sound leakage from a portion where the transmission member is provided is generated. On the other hand, the vehicle glass 1 according to the present embodiment is provided with the cover portion 30 in such a manner that the first space S1 is blocked. Thus, according to the present embodiment, it is possible to control the sound leakage while appropriately transmitting the far-infrared rays.

The present disclosure describes the following inventions. Note that these are not limitations.

(1): A vehicle glass including: a glass member 10 in which an opening portion 19 penetrating from a surface 10A on a vehicle exterior side to a surface 10B on a vehicle interior side is formed; a transmission member 20 that is arranged in the opening portion 19 and transmits far-infrared rays; and a cover portion 30 that covers a surface 20b on the vehicle interior side of the transmission member 20, in which the cover portion 30 blocks a first space S1 that is on the vehicle interior side compared to the glass member 10 and that includes the surface 20b on the vehicle interior side of the transmission member 20 from a space other than the first space S1 on the vehicle interior side compared to the glass member 10 (second space S2).

(2): The vehicle glass according to (1), in which the cover portion 30 includes a housing 32 that covers the surface 20b on the vehicle interior side of the transmission member 20, and a fixation portion 34 that surrounds an outer periphery of the surface 20b on the vehicle interior side of the transmission member 20 and fixes the housing 32 to the surface 10B on the vehicle interior side of the glass member 10.

(3) The vehicle glass according to (1) or (2), further including a camera attachment portion 50 that is provided in the first space S1 and fixes a far-infrared camera CA1 to the surface 10B on the vehicle interior side of the glass member 10.

(4): The vehicle glass according to (3), in which the housing 32 is formed with an outlet 32a that is an opening from which a wiring line W of the far-infrared camera CA1 is extracted to an outside of the first space S1, and a closing portion 36 that closes the outlet 32a is further included.

(5): The vehicle glass according to any one of (1) to (4), further including a protection member 40 that is provided in the first space S1 and overlaps with at least a part of the transmission member 20 in a case of being viewed in a direction orthogonal to the surface 20a on the vehicle exterior side of the transmission member 20.

(6): The vehicle glass according to any one of (1) to (5), further including a sound absorbing material 60 provided in the first space S1.

(7): The vehicle glass according to (6), in which the sound absorbing material 60 is provided on an inner surface of the cover portion 30.

(8): A camera unit including: the vehicle glass 1 according to any one of (1) to (7); and a far-infrared camera CA1 provided in the first space S1.

### (Another Example of a Transmission Member)

A transmission member 20 may include a layer other than a base material 22. For example, the transmission member 20 may include an antireflection film (AR film) that controls reflection of far-infrared rays on at least one of a plane on a vehicle interior side or a plane on a vehicle exterior side of the base material 22. The antireflection film may have any configuration, and may have a configuration in which a high refractive index layer and a low refractive index layer are alternately laminated, for example. In this case, in the antireflection film, one each or a plurality of the high refractive index layers and the low refractive index layers may be laminated.

The high refractive index layer is a film having a high refractive index with respect to the far-infrared rays, and has a refractive index of preferably 2.5 or more and 4.5 or less, more preferably 3.0 or more and 4.5 or less, and still more preferably 3.3 or more and 4.3 or less with respect to light having a wavelength of 10 μm. A material of the high refractive index layer may be arbitrary, and examples thereof include what includes at least one material selected from a group of Si and Ge as a main component, diamond-like carbon (DLC), ZnSe, As₂S₃, and As₂Se₃.

The low refractive index layer is a film having a low refractive index with respect to far-infrared rays, and has a refractive index of preferably 0.8 or more and 2.0 or less, more preferably 1.0 or more and 1.7 or less, and still more preferably 1.0 or more and 1.5 or less with respect to the light having the wavelength of 10 μm. A material of the low refractive index layer may be arbitrary, and examples thereof include ZnS, metal oxide (such as SiOₓ, Al₂O₃, NiOₓ, CuOₓ, ZnO, ZrO₂, Bi₂O₃, Y₂O₃, CeO₂, HfO₂, MgO, TiOₓ, or the like), and metal fluoride (such as MgF₂, CaF₂, SrF₂, BaF₂, PbF₂, LaF₃, YF₃, or the like).

Furthermore, for example, in a transmission member 20, a visible light absorbing layer may be formed on at least one of a plane on a vehicle interior side or a plane on a vehicle exterior side of a base material 22. The visible light absorbing layer is a layer that absorbs visible light. The visible light absorbing layer has an extinction coefficient of preferably 0.04 or more, more preferably 0.05 or more, more preferably 0.06 or more, more preferably 0.07 or more, more preferably 0.08 or more, and more preferably 0.10 or more with respect to light having a wavelength of 550 nm. In addition, the visible light absorbing layer has an average extinction coefficient of preferably 0.04 or more, more preferably 0.05 or more, more preferably 0.06 or more, more preferably 0.07 or more, more preferably 0.08 or more, and more preferably 0.10 or more with respect to light having a wavelength of 380 nm to 780 nm. When the extinction coefficient and the average extinction coefficient fall within these ranges, it is possible to appropriately control reflectance dispersion of the visible light and acquire an appearance securing designability.

The visible light absorbing layer can transmit the far-infrared rays. The visible light absorbing layer has an extinction coefficient of preferably 0.1 or less, more preferably 0.05 or less, and still more preferably 0.02 or less with respect to the light having the wavelength of 10 μm.

A material of the visible light absorbing layer is arbitrary. Preferably, metal oxide is included as a main component. Here, the main component may indicate that the content with respect to the entire visible light absorbing layer is 50 mass % or more. The metal oxide used in the visible light absorbing layer is preferably at least any of a nickel oxide (NiOₓ), a copper oxide (CuOₓ), or a manganese oxide (MnOₓ). The visible light absorbing layer preferably includes at least one material selected from a group of NiOₓ, CuOₓ, and MnOₓ as a main component. It can be said that the visible light absorbing layer preferably includes NiOₓ as the main component or includes at least one material selected from a group of CuOₓ and MnOₓ as the main component. Note that it is known that the nickel oxide, the copper oxide, and the manganese oxide have a plurality of compositions according to valences of nickel, copper, and manganese, and x can be any value from 0.5 to 2. In addition, the valence may not be single, and two or more kinds of valences may be mixed. In the present embodiment, NiO is preferably used as NiOₓ, CuO is preferably used as CuOₓ, and MnO is preferably used as MnOₓ. However, the material of the visible light absorbing layer is not limited to these materials and may be any material such as diamond-like carbon (DLC).

For example, a protection film may be formed on a plane, which is on the outermost side of the vehicle, of the transmission member 20. The protection film preferably includes, for example, at least one material selected from a group of ZrO₂, Al₂O₃, TiO₂, Si₃N₄, AlN, and diamond-like carbon (DLC). By forming the protection film, it is possible to appropriately protect the transmission member 20.

### EXAMPLES

Next, examples will be described.

### First Example

A glass member in which PVB having a thickness of 0.76 mm was arranged between soda-lime glass having a size of 300 mm×300 mm and a thickness of 2.0 mm was prepared as vehicle glass.

### Second Example

As a base material, Si (FZ grade (manufactured by FZ method)) having a diameter of 50 mm and a thickness of 2.0±0.05 mm was prepared. Note that the thickness was measured with digital calipers (CD-15CX manufactured by Mitutoyo Corporation).

Then, a film of diamond-like carbon (DLC) was formed for 1000 nm on a plane on the vehicle exterior side of the base material by plasma CVD. Then, a Ge film (100 nm) and then a ZnS film (1200 nm) were formed on a plane on the vehicle interior side of the base material by vapor deposition and a transmission member is acquired.

A through hole (opening portion) having a diameter of 54 mm on the vehicle exterior side and a diameter of 49 mm on the vehicle interior side was formed at a center of a glass member that is the same as that in the first example.

Then, a transmission member-mounted attachment produced by adhesion of the attachment and the prepared transmission member by utilization of a urethane-based adhesive was attached to the through hole in such a manner that an outer surface of the transmission member was flush with a surface on the vehicle exterior side of the laminated glass, and vehicle glass of the second example was acquired. Note that the attachment is an ABS frame member provided on an outer peripheral edge of the transmission member.

### Third Example

Vehicle glass of the third example was acquired by a method similar to that of the second example except that a through hole formed in a glass member had a diameter of 53.5 mm.

### Fourth Example

A cover portion was provided on vehicle glass acquired by a method similar to that of the third example, and vehicle glass of the fourth example was acquired. Specifically, a cover portion was acquired by a casting method with a simple mold by utilization of an acrylonitrile butadiene styrene copolymer (ABS). The acquired cover portion was placed on a surface on the vehicle interior side of a glass member in such a manner as to cover a surface on the vehicle interior side of a transmission member. In the fourth example, a gap between the cover portion and the glass member was not closed, and a space in the cover portion was not shielded.

### Fifth Example

In vehicle glass acquired by a method similar to that of the fourth example, a space in a cover portion was shielded, and vehicle glass of the fifth example was acquired. In the fifth example, a gap between the cover portion and a glass member was closed with a duct tape.

### Sixth Example

In vehicle glass acquired by a method similar to that of the fifth example, a sound absorbing material (CALMFLEX F-9M manufactured by INOAC CORPORATION) was arranged on an inner surface of a cover portion, and vehicle glass of the sixth example was acquired.

### Seventh Example

In vehicle glass acquired by a method similar to that of the fifth example, a polyester cotton sound absorbing material was arranged on an inner surface of a cover portion, and vehicle glass of the seventh example was acquired.

### (Evaluation)

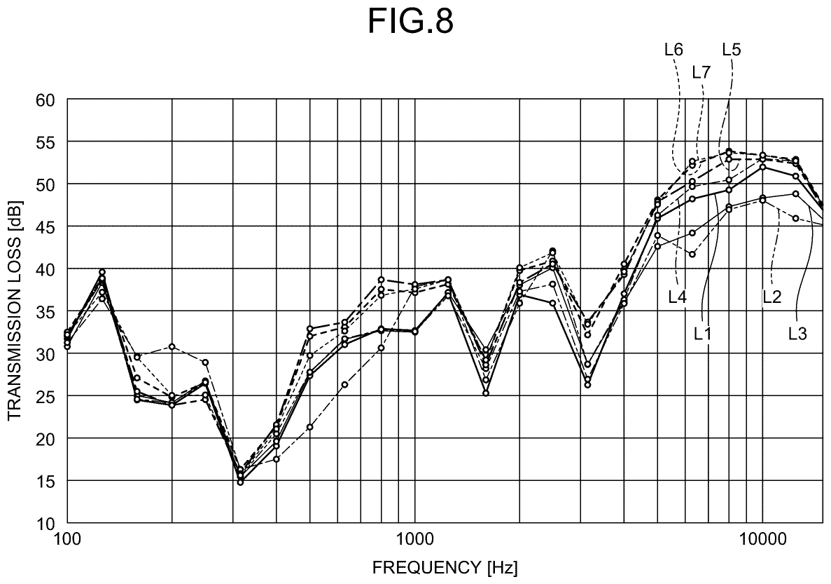

FIG. 8 is a graph illustrating a transmission loss evaluation result of each of the examples. For the vehicle glass of each of the examples, a transmission sound was evaluated by utilization of the following measurement device.

An evaluation device includes an acrylic sound insulation box having an opening portion, a speaker that is installed in the sound insulation box and generates white noise, and a microphone arranged above the sound insulation box, and the device is installed in a room simulating an anechoic field. An analyzer is attached to the microphone and a frequency of a sound pressure level can be measured.

A sample was fixed to the opening portion of the evaluation device in such a manner that sound leakage from a periphery was not generated, and a transmission sound pressure of the white noise generated from the speaker was evaluated in a range of 100 Hz to 15000 Hz.

The evaluation result of each of the examples is illustrated in FIG. 8. In FIG. 8, a horizontal axis represents a frequency (Hz) of a sound wave used for sound leakage evaluation, and a vertical axis represents the transmission loss (dB). Lines L1 to L8 in FIG. 8 respectively indicate the transmission losses at each frequency of the pieces of vehicle glass of the first example to the eighth example. The sound leakage becomes smaller (sound insulation property becomes higher) as the transmission loss becomes higher.

The first example to the fourth example are comparative examples, and the fifth example to the seventh example are the examples.

As illustrated in the second example and the third example, it can be seen that, in a case where the opening portion is formed in the glass member and the transmission member is arranged, the sound leakage is increased as compared with the first example in which the opening is not formed.

As illustrated in the fourth example, it can be seen that the sound leakage can be controlled to some extent by the arrangement of the cover portion as compared with the first example to the third example and the like even in a case where the opening portion is formed and the transmission member is arranged.

As illustrated in the fifth example, it can be seen that it is possible to suitably control the sound leakage as compared with the first example to the fourth example and the like by providing the cover portion in such a manner as to shield the space in the cover portion.

As illustrated in the sixth and seventh examples, it can be seen that it is possible to further control the sound leakage by providing the sound absorbing material while shielding the space in the cover portion.

Although an embodiment of the present invention has been described above, embodiments are not limited by the contents of the embodiment. In addition, the above-described components include what can be easily assumed by those skilled in the art, what is substantially the same, and what is in a so-called equivalent range. Furthermore, the above-described components can be appropriately combined. Furthermore, various omissions, substitutions, or changes in the components can be made without departing from the gist of the above-described embodiment.

### REFERENCE SIGNS LIST

1 VEHICLE GLASS
10 GLASS MEMBER
19 OPENING PORTION
20 TRANSMISSION MEMBER
30 COVER PORTION
40 PROTECTION MEMBER
42 SURFACE PORTION
CA1 FAR-INFRARED CAMERA
S1 FIRST SPACE
V VEHICLE

1. A vehicle glass comprising:
a glass member in which an opening portion penetrating from a surface on a vehicle exterior side to a surface on a vehicle interior side is formed;
a transmission member that is arranged in the opening portion and transmits far-infrared rays; and
a cover portion that covers a surface on the vehicle interior side of the transmission member, wherein
the cover portion blocks a first space that is on the vehicle interior side compared to the glass member and that includes the surface on the vehicle interior side of the transmission member from a space other than the first space on the vehicle interior side compared to the glass member,
further comprising a sound absorbing material provided in the first space.

2. The vehicle glass according to claim 1, wherein
the cover portion includes
a housing that covers the surface on the vehicle interior side of the transmission member, and
a fixation portion that surrounds an outer periphery of the surface on the vehicle interior side of the transmission member and fixes the housing to the surface on the vehicle interior side of the glass member.

3. The vehicle glass according to claim 2, further comprising a camera attachment portion that is provided in the first space and that fixes a far-infrared camera to the surface on the vehicle interior side of the glass member.

4. The vehicle glass according to claim 3, wherein
an outlet that is an opening from which a wiring line of the far-infrared camera is taken out to an outside of the first space is formed in the housing,
the vehicle glass further comprising a closing portion that closes the outlet.

5. The vehicle glass according to claim 1, further comprising a protection member that is provided in the first space and overlaps with at least a part of the transmission member in a case of being viewed in a direction orthogonal to a surface on the vehicle exterior side of the transmission member.

6. The vehicle glass according to claim 1, wherein the sound absorbing material is provided on an inner surface of the cover portion.

7. A camera unit comprising: the vehicle glass according to claim 1; and a far-infrared camera provided in the first space.
